(19) United States
(12) Patent Application Publication
(10) Pub. No.: US 2008/0039961 A1
(43) Pub. Date: Feb. 14, 2008

(54) Control Systems for a Motor Vehicle

(75) Inventors: Guenter Metsch, Moeglingen (DE); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgat (DE)

(21) Appl. No.: 10/584,458

(22) PCT Filed: Dec. 4, 2004
(86) PCT No.: PCT/EP04/13800

§ 371 Date: Mar. 15, 2007

(30) Foreign Application Priority Data
Dec. 23, 2003 (DE) 103 60 662.9

(51) Int. Cl. B60R 16/02

(52) U.S. Cl. 700/83

(57) ABSTRACT

A control system for a motor vehicle has a manual actuating device with a plurality of degrees of freedom of adjustment for selecting and/or activating entries in a menu structure with a plurality of menu levels. The system also has a screen display with a plurality of display areas for displaying the menu structure. Each of the display areas comprises at least one field for displaying one of the entries. In at least one level of the menu structure, at least one display area which is active for selecting an entry can be displayed on the screen display. At least one subarea of the other display areas is displayed graphically in a different way than the at least one active display area.

### BACKGROUND AND SUMMARY OF THE INVENTION

This invention relates to a control system for a motor vehicle.

In modern vehicles, multimedia control systems are being increasingly used. An example of this is the command system in the Mercedes Benz S-class.

German document DE 197 52 056 A1 describes a control system of this general type for a motor vehicle. In this control system, two display areas are displayed on a screen display in a menu structure with a plurality of menu levels. A first display area is arranged as a frame around the second display area. In a first menu level, eight fields with entries which correspond to applications which can be carried out and which are arranged vertically and horizontally are displayed in the first display area. An entry is selected by a pushing or tilting movement of the manual actuating means with a plurality of degrees of freedom of adjustment in the direction of the position of the corresponding entry in the first display area. A selected entry is activated by pressing the manual actuating means. After the activation, a plurality of vertically arranged entries which are assigned to the activated entry in the first menu level are displayed in a second menu level in the second display area. The entries displayed in the second display area are selected by means of rotational movement of the manual actuating means and activated by pressing the manual actuating means. The activated second display area and the second menu level are exited by the pushing or tilting movement of the manual actuating means in the direction of a position of one of the entries in the first display area. The control system is then located in the first menu level in the first display area again.

The object of the invention is to provide an improved control system for a motor vehicle which permits intuitive control and which reduces the scope of distracting information.

The invention achieves this object by making available a control system having the features claimed.

Advantageous developments of the invention are also claimed.

In at least one level of the menu structure at least one display area which is active for selecting an entry can be displayed on the screen display, at least a subarea of the other display areas is displayed graphically in a different way than the at least one active display area.

In one advantageous embodiment of the invention, the other graphic display is combined with a timing function which is activated as a function of the actuation of the manual actuating means.

This timing function is implemented, for example, as a predefinable time period which is reset and restarted by actuating a manual actuating means. The graphic display of the at least one subarea is changed after the predefinable time period has expired.

In one refinement, the other graphic display is dependent as a function of one of the many levels being reached, and as a result, the display of a display area which is active in a relatively high menu level can be changed in a relatively low menu level, with the original or the usual display of the display area which is then active again being resumed upon return to the relatively high menu level.

The changed display may be implemented by a different color and/or a different intensity and/or a different contrast than in the active display area.

In a further refinement, the intensity and/or the contrast of the graphic display of the at least one subarea can be changed in a continuously or incrementally decreasing fashion as a function of a further predefinable time period.

In addition it is possible to remove the at least one subarea from the display completely.

One of the display areas in at least one menu level is selected and/or activated by means of a first and/or a second of a plurality of degrees of freedom of adjustment of the manual actuating means with which an entry or a parameter of a plurality of entries or parameters which are arranged in this display area is selected and/or activated. The first and second degrees of freedom of adjustment are able to correspond to an orientation of the entries which are arranged in the active display area. In order to exit the active display area, a third and/or a fourth degree of freedom of adjustment of the manual actuating means may be present, each being orthogonal with respect to the orientation of the displayed entries.

In one advantageous refinement, when the at least one entry or the at least one settable parameter is arranged vertically in the active display area, the first degree of freedom of adjustment corresponds to pushing the manual actuating means in a positive y direction, and the second degree of freedom of adjustment corresponds to pushing the manual actuating means in a negative y direction. The third degree of freedom of adjustment corresponds to pushing the manual actuating means in a positive x direction, and the fourth degree of freedom of adjustment corresponds to pushing the manual actuating means in a negative x direction.

When the at least one entry or the at least one parameter is arranged horizontally in the active display area, the first degree of freedom of adjustment corresponds to pushing the manual actuating means in the positive x direction, and the second degree of freedom of adjustment corresponds to pushing the manual actuating means in the negative x direction. The third degree of freedom of adjustment corresponds to pushing the manual actuating means in the positive y direction, and the fourth degree of freedom of adjustment corresponds to pushing the manual actuating means in the negative y direction.

In addition, a fifth degree of freedom of adjustment may be present which corresponds to pushing the manual actuating means in a negative z direction. This fifth degree of freedom can be used, for example, for activating the selected entry or for storing a parameter setting which has been made.

Advantageous refinements of the invention are displayed in the drawings and are described below.

### BRIEF DESCRIPTION OF THE DRAWINGS

FIG. 1 is a block circuit diagram of a control system for a motor vehicle;

FIG. 2 is a schematic illustration of a screen display from FIG. 1 in a first menu level;

FIG. 3 is a schematic illustration of a screen display from FIG. 1 in a further menu level;

FIG. 4 is a schematic illustration of the screen display from FIG. 1 in a further menu level; and

FIG. 5 is a schematic illustration of the screen display from FIG. 1 in a further menu level.

### DETAILED DESCRIPTION OF THE INVENTION

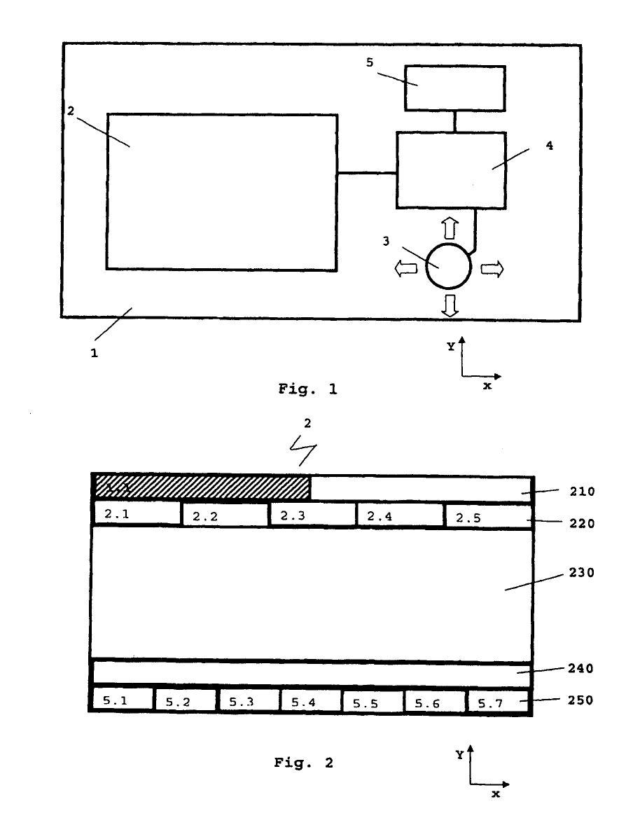

As is apparent from FIG. 1, the control system 1 for a motor vehicle comprises a screen display 2, a manual actuating means 3, a control and evaluation unit 4 and a plurality of vehicle systems such as a navigation system, a heating system and an air conditioning system, a cellular telephone, a video system, an audio system etc. which are illustrated combined as one element 5. The vehicle systems transmit signals to the evaluation and control unit 4 from which the control and evaluation unit 4 determines current system states. All the applications and/or functions and/or subfunctions and/or options and/or status displays in various menu levels of a menu structure are controlled by means of the manual actuating means 3. The latter has seven degrees of freedom of adjustment for selecting and/or activating entries displayed in an active display area. The actuating means 3 can be pushed in four directions according to the arrow illustration in FIG. 1, i.e. in a positive x direction, a negative x direction, in a positive y direction or in a negative y direction. In addition, the actuating means can be rotated in the clockwise direction or in the counter clockwise direction about a z axis (not illustrated) which is perpendicular to the plane of the drawing, and can be pressed in the direction of the negative z direction, i.e. into the plane of the drawing.

Rotating the manual actuating means 3 in the clockwise direction causes a cursor on the screen 2 to move to the right or downward as a function of a horizontal or vertical orientation of the entries displayed on the screen display 2, and turning in the counter clockwise direction causes the cursor to move to the left or upward. Pushing the manual actuating means 3 in FIG. 1 upward, i.e. forward in the direction of the windshield, i.e. in the positive y direction, causes the cursor on the screen display 2 to move upward, and the pushing process in the downward direction in FIG. 1, i.e. toward the rear in the negative y direction, causes the cursor on the screen display 2 to move downward. Pushing to the right, i.e. in the positive x direction, causes the cursor on the screen display 2 to move to the right, and pushing to the left, i.e. in the negative x direction, causes the cursor to move to the left.

The selection and/or activation of an entry displayed on the screen display 2 are carried out by pushing or turning the manual actuating means 3. In a redundant way with respect to the vertical pushing along an axis, i.e. with respect to the pushing in the y direction or with respect to the horizontal pushing along an axis, i.e. with respect to the pushing in the x direction, the manual actuating means 3 can be rotated about the z axis. The pushing movement in order to select an entry corresponds here according to the invention to the orientation of the entries displayed in the active display area. The pushing direction which is respectively orthogonal with respect to the selection pushing direction causes for example the active display area to be exited. In addition, in order to activate a selected entry or to save a set parameter, it may be necessary to press the manual actuating means 3.

As is clear from FIG. 2, the screen display 2 comprises, in a first menu level, a graphic basic structure of five vertically arranged, horizontal display areas 210 to 250. This graphic basis structure is constant over the multiplicity of various menu levels of the menu structure. The screen display 2 is configured, for example, as an eight inch screen with a ratio of the sides of 15:9. The graphic basic structure of at least a first of the display areas 210 to 250 of the screen display 2 is constant over the multiplicity of various menu levels of the menu structure. In FIG. 2, the display areas 210, 220, 240 and 250 are configured as such first display areas.

The graphic basis structure of at least a second of the display areas 210 to 250 is variable over the multiplicity of various menu levels of the menu structure as a function of an activated application and/or function and/or subfunction and/or option and/or status display. In FIG. 2, the display area 230 is configured as such as second display area. This central display area 230 may be configured graphically in very different ways.

One or more horizontally arranged entries 1.1 to 5.7 may be respectively displayed in the four display areas 210, 220, 240 and 250 which are configured as first display areas. For example, the display areas 210, 220, 240 and 250 in FIG. 2 in the first menu level each comprise a different number of entries. For example, the first display area 210 comprises one entry 1.1, the second display area 220 comprises five entries 2.1 to 2.5, the fourth display area comprises no entry and the fifth display area comprises seven entries 5.1 to 5.7. In FIG. 2, the first display area 210 is activated and the hatched entry 1.1. is selected. The hatched display is intended to indicate that the cursor is positioned on the entry 1.1.

The entries 1.1 to 5.7 of the display areas 210 to 250 displayed on the screen display 2 can be arranged according to the importance of their contents or their frequency of application. When the entries are arranged vertically, the width of the individual fields for displaying the entries 1.1 to 5.7 is dependent, for example, on the length of the longest entry. The field width can be additionally or alternatively dependent on the number of fields in a display area.

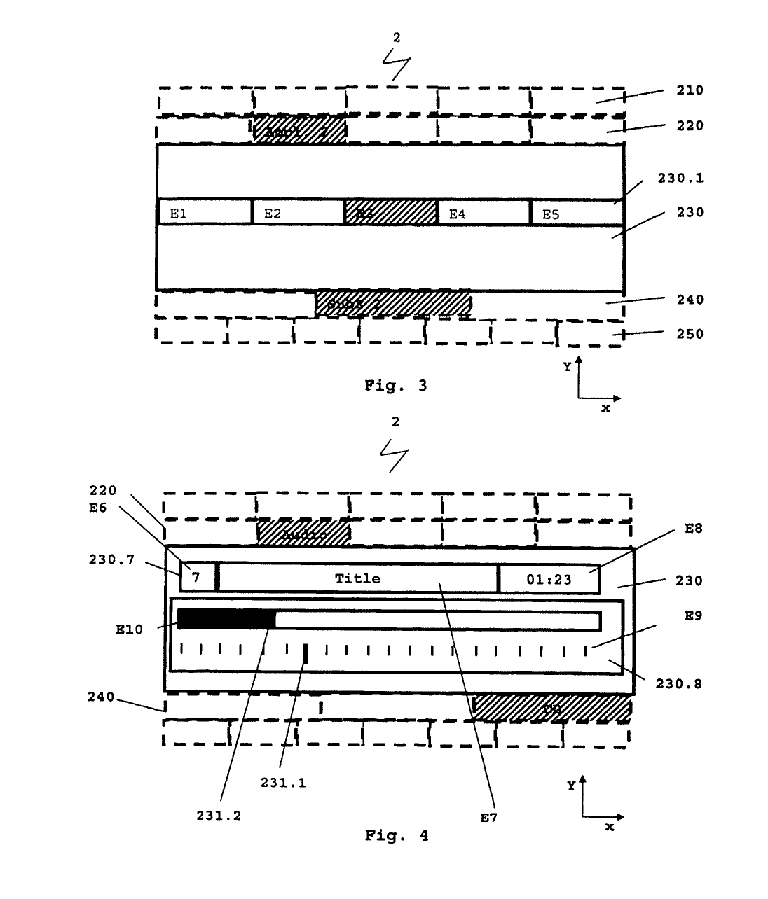

FIG. 3 shows the screen display 2 in a third menu level after an application Appl. 2 has been activated in the second display area 220 and a subfunction SubF 2 has been selected and activated in the display area 240. In the third display area 230, a display area 230.1 which is embodied as a horizontal submenu list is activated. The cursor is positioned in the display area 230.1 on a hatched field with an entry E3 from which further entries E1, E2, E3 or E4 can be selected and activated by a corresponding pushing movement of the manual actuating means 3. The entries E1 and E2 can be selected and activated by a pushing movement in the negative x direction, and the entries E4 and E5 can be selected and activated by a pushing movement in the positive x direction.

In one embodiment (not illustrated), the entries E1 to E5 are arranged in a vertical submenu list and can be selected and activated by corresponding pushing movements of the manual actuating means in a positive or negative y direction.

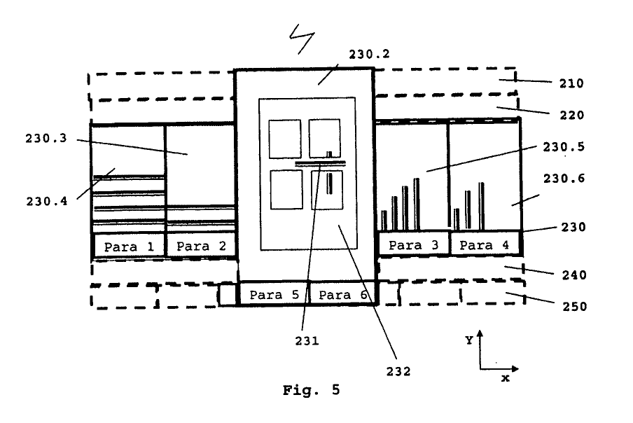

FIG. 4 shows the screen display 2 in a third menu level after an application Audio has been activated in the second display area 220, and a subfunction CD has been selected and activated in the display area 240. In the third display area 230, a display area 230.7 and a display area 230.8 are activated, the display area 230.8 comprising a first entry E9 which is configured as a dashed bar, and a second entry E10 which is embodied as a level display. The second entry is a display of a detail of an activated subentry of the first entry. The cursor is embodied in the first entry E9 as a vertical bar 231.1 and is positioned on the seventh subentry. In the illustrated exemplary embodiment, the subentries represent music titles of a CD. In total there are twenty music titles on the CD, the seventh music title of which is activated and is currently being played.

The cursor is configured in the second entry as a horizontal, variable bar 231.2 and indicates the proportion of the second entry which has already been played, and represents the total playing time of the seventh music title activated in the first entry.

The display area 230.7 corresponds to a further display of a detail of the selected and/or activated submenu within the first entry and cannot be selected by the user. The display area 230.7 is embodied as a horizontally arranged list and comprises three entries in the illustrated exemplary embodiment. The display area 230.7 is, like the second entry E10 in the display area 230.8, coupled to the first entry E9 in the display area 230.8. An entry E6 shows the number of the currently selected and/or activated subentry of the first entry E9. An entry E7 indicates the title of the selected and/or activated subentry, and an entry E8 indicates the playing time of the activated subentry which has already been played. The display area 230.7 has a pure display function and can therefore not be selected by the user. This may be indicated, for example, by a changed visual representation, for example by a different color and/or intensity.

FIG. 5 shows, for example, various display areas 230.2 to 230.6 for setting parameters Para 1 to Para 6 within the third display area 230.

The display areas 230.3 and 230.4 serve to set vertically arranged parameters Para 1 and Para 2 by pushing the manual actuating means 3 in the positive or negative y direction or by rotating the manual actuating means 3 in the clockwise direction or in the counterclockwise direction.

The display areas 230.5 and 230.6 serve to set horizontally arranged parameters Para 3 and Para 4 by pushing the manual actuating means 3 in the positive or negative x direction or by rotating the manual actuating means 3 in the clockwise direction or in the counterclockwise direction.

The display area 230.2 serves for simultaneously setting two parameters Para 5 and Para 6. The cursor 231 for this setting is implemented as cross hairs which can be moved within a schematically represented passenger compartment of a vehicle, the current value of the parameter Para 5 is displayed by the horizontally arranged bar and the current value of the parameter Para 6 is displayed by the vertically arranged bar. The parameter Para 5 is set by rotating or vertical pushing, and the parameter Para 6 by horizontal pushing of the manual actuating means 3.

The parameters Para 1 to Para 4 represent, for example, sound functions such as bass, treble, volume, etc. and the parameters Para 5 and Para 6 represent, for example, sound functions such as balance and fade in an audio application.

The exiting of one of these display areas 230.2 to 230.6 is brought about by pressing the manual actuating means 3. After a parameter setting has been made, the currently set parameter value Para 1 to Para 6 is stored by pressing the manual actuating means 3, and the activated display area 230.2 to 230.6 is exited.

The dashed representation of the display areas 210, 220, 240 and 250 and of the associated fields in FIGS. 3 to 5 is intended to indicate that these display areas 210, 220, 240 and 250 are not active in the menu level shown and therefore are displayed graphically in a different way. The changed graphic display may take the form, for example, of using a different color and/or a lower intensity and/or a lower contrast than are used for displaying the active display area 230.

The variable display of the display areas 210, 220, 240 and 250 which are currently not active is activated, for example, as a function of the actuation of the manual actuating means 3 and of a timing function. Here, the timing function is activated by actuating the manual actuating means 3. The timing function is implemented, for example, by a predefinable time period. If no further actuation of the manual actuating means 3 occurs within this time period, the display of the display areas 210, 220, 240 and 250 which are not active is changed.

In addition, after this time period has expired it is possible to predefine a further time period. Within this further time period, the color and/or the intensity and/or the contrast of the graphic display of the non-activated display areas 210, 220, 240 and 250 can be changed continuously or incrementally, the intensity and/or the contrast being preferably decreased.

The change in the graphic display or the reduction of the intensity and/or the contrast can also cause the nonactive display areas 210, 220, 240 and 250 to be removed from the display completely.

In the exemplary embodiments illustrated in FIGS. 3 and 4, the display areas 210 and 240 which are shown by dashes with their associated entries are removed completely from the display while the display areas 220 and 240 are removed from the display completely only in certain areas. In order to highlight the previous operator control process, in FIG. 3 the entry Appl. 2 which is selected and activated in a relatively high menu level is shown in the nonactive display area 220, and the entry SubF 2 is shown in the display area 240. In FIG. 4, the entry Audio is shown in the display area 220, and the entry CD is shown in the display area 240.

In the currently nonactive display areas 210, 220, 240 and 250, the entries Appl. 2, SubF 2, Audio and CD which are selected and activated in a relatively high menu level can be displayed with a lesser intensity and/or with a lesser contrast and/or with a different color.

In the exemplary embodiment from FIG. 5, all the nonactive display areas 210, 220, 240 and 250 which are shown by dashed lines are removed completely from the display and therefore cannot be seen.

Actuating the manual actuating means 3 causes the currently nonactive display areas 210, 220, 240 and 250 to be displayed in the usual way again, in which case the active display area 230 can then be visually highlighted.

The inventive changed display of the nonactive display areas decreases the amount of information to be absorbed by the user and therefore reduces the cognitive load. This makes it easier to operate the respective active display area intuitively and to exit the active display area intuitively. As a result, the user can concentrate better on the events on the road.

1-10. (canceled)

11. A control system for a motor vehicle, comprising:
a manual actuating means with a plurality of degrees of freedom of adjustment for selecting, activating, or both selecting and activating entries in a menu structure with a plurality of menu levels, and
a screen display having a plurality of display areas for displaying the menu structure, the display areas each including at least one field for displaying one of the entries,
wherein, in at least one level of the menu structure, at least one display area which is active in order to select an entry can be displayed on the screen display, and
wherein at least one subarea of the other display areas is displayed graphically in a different way than the at least one active display area.

12. The operating system as claimed in claim 11, wherein the different graphic display can be combined with a timing function which can be activated as a function of actuation of the manual actuating means.

13. The operating system as claimed in claim 12, wherein the timing function is implemented as a predefinable time period which is reset and restarted by actuating the manual actuating means, and wherein the graphic display of the at least one subarea can be changed after the predefinable time period has expired.

14. The operating system as claimed in claim 11, wherein the different graphic display can be activated as a function of one of the menu levels.

15. The operating system as claimed in claim 11, wherein the at least one subarea of the other display areas can be displayed with at least one of a different color, a different intensity, and a different contrast than the active display area.

16. The operating system as claimed in claim 15, wherein at least one of intensity and contrast of the graphic display of the at least one subarea can be changed in a continuously or incrementally decreasing fashion as a function of a further predefinable time period.

17. The operating system as claimed in claim 11, wherein the at least one subarea is removed from the display completely.

18. The operating system as claimed in claim 11, wherein, in the active display area in at least one menu level, at least one of a first and a second of the plurality of degrees of freedom of adjustment of the manual actuating means for selecting and/or activating one of the entries corresponds to an orientation of entries displayed in the active display area, and wherein at least one of a third and a fourth degree of freedom of adjustment of the manual actuating means for exiting the active display area is respectively orthogonal to the orientation of the displayed entries.

19. The operating system as claimed in claim 18, wherein, when the at least one entry is arranged vertically in the active display area, the first degree of freedom of adjustment is pushing the manual actuating means in a positive y direction, the second degree of freedom of adjustment is pushing the manual actuating means in a negative y direction, the third degree of freedom of adjustment is pushing the manual actuating means in a positive x direction, and the fourth degree of freedom of adjustment is pushing the manual actuating means in a negative x direction of an xyz coordinate system.

20. The operating system as claimed in claim 18, wherein, when the at least one entry is arranged horizontally in the active display area, the first degree of freedom of adjustment is pushing the manual actuating means in a positive x direction, the second degree of freedom of adjustment is pushing the manual actuating means in a negative x direction, the third degree of freedom of adjustment is pushing the manual actuating means in a positive y direction, and the fourth degree of freedom of adjustment is pushing the manual actuating means in a negative y direction of an xyz coordinate system.

21. The operating system as claimed in claim 12, wherein the different graphic display can be activated as a function of one of the menu levels.

22. The operating system as claimed in claim 13, wherein the different graphic display can be activated as a function of one of the menu levels.

23. The operating system as claimed in claim 12, wherein the at least one subarea of the other display areas can be displayed with at least one of a different color, a different intensity, and a different contrast than the active display area.

24. The operating system as claimed in claim 13, wherein the at least one subarea of the other display areas can be displayed with at least one of a different color, a different intensity, and a different contrast than the active display area.

25. The operating system as claimed in claim 14, wherein the at least one subarea of the other display areas can be displayed with at least one of a different color, a different intensity, and a different contrast than the active display area.

26. The operating system as claimed in claim 12, wherein the at least one subarea is removed from the display completely.

27. The operating system as claimed in claim 13, wherein the at least one subarea is removed from the display completely.

28. The operating system as claimed in claim 14, wherein the at least one subarea is removed from the display completely.

29. The operating system as claimed in claim 12, wherein, in the active display area in at least one menu level, at least one of a first and a second of the plurality of degrees of freedom of adjustment of the manual actuating means for selecting and/or activating one of the entries corresponds to an orientation of entries displayed in the active display area, and wherein at least one of a third and a fourth degree of freedom of adjustment of the manual actuating means for exiting the active display area is respectively orthogonal to the orientation of the displayed entries.

30. The operating system as claimed in claim 13, wherein, in the active display area in at least one menu level, at least one of a first and a second of the plurality of degrees of freedom of adjustment of the manual actuating means for selecting and/or activating one of the entries corresponds to an orientation of entries displayed in the active display area, and wherein at least one of a third and a fourth degree of freedom of adjustment of the manual actuating means for exiting the active display area is respectively orthogonal to the orientation of the displayed entries.
